(19) United States
(12) Patent Application Publication
(10) Pub. No.: US 2023/0187108 A1
(43) Pub. Date: Jun. 15, 2023

(54) Magnet Device

(71) Applicant: Kasia Webley, Florence, SC (US)

(72) Inventor: Kasia Webley, Florence, SC (US)

(21) Appl. No.: 18/064,338

(22) Filed: Dec. 12, 2022

Related U.S. Application Data
(60) Provisional application No. 63/288,714, filed on Dec. 13, 2021.

(51) Int. Cl. H01F 7/02

(52) U.S. Cl. CPC H01F 7/0257; H01F 7/0221

(57) ABSTRACT

The present invention relates to a magnet device. The device is primarily comprised of a wire mesh, a magnet, and a telescoping arm. The wire mesh is comprised of at least one opening that allows a user to remove the wire mesh from the magnet when it is time to dispose of the collected metal items. In addition, the magnet is comprised of at least one magnetic base, at least one magnetic support, and at least one magnetic topper so that a user can easily pick up small to medium-sized metallic items without causing strain or injury to their back or other muscles. Further, the telescoping arm which allows the device to be used at a plurality of distances.

### CROSS-REFERENCE TO RELATED APPLICATION

The present application claims priority to, and the benefit of, U.S. Provisional Application No. 63/288,714, which was filed on Dec. 13, 2021, and is incorporated herein by reference in its entirety.

### FIELD OF THE INVENTION

The present invention relates generally to the field of magnet devices. More specifically, the present invention relates to a magnet device that is primarily comprised of a wire mesh, a magnet, and a telescoping arm. In the preferred embodiment, the wire mesh is comprised of at least one opening that allows a user to remove the wire mesh from the magnet when it is time to dispose of the collected metal items. In the preferred embodiment, the magnet is comprised of at least one magnetic base, at least one magnetic support, and at least one magnetic topper. The magnetic base acts as the primary magnet for the device so that a user can easily pick up small to medium-sized metallic items without causing strain or injury to their back or other muscles. The device is also comprised of a telescoping arm which allows the device to be used at a plurality of distances. In this manner, the user can easily retrieve items without the need to bend over. Accordingly, the present disclosure makes specific reference thereto. Nonetheless, it is to be appreciated that aspects of the present invention are also equally applicable to other like applications, devices, and methods of manufacture.

### BACKGROUND

Many people frequently drop metal items in their daily lives. For example, a carpenter may find themselves with nails, screws, or drill bits scattered about their working area on a daily basis. Similarly, a teacher or office worker may have staples, pins, or paperclips scattered around the classroom floor or under their desk.

As a result, said individuals will have to spend time bent over collecting each individual item. This process can be tedious and time-consuming, as some metal items may not be easily visible to the human eye. In addition, bending over to pick up these items can be stressful on the back and other muscles, which can lead to injury. If these items are left on the floor and an individual tries to vacuum the floor surface, the objects could be suctioned into the vacuum and cause damage.

Therefore, there exists a long-felt need in the art for an improved magnet device. There also exists a long-felt need in the art for a magnet device that can be used without the need to bend over to grab metal items such as hairpins or screws in an effort to avoid stress on the back and other muscles. In addition, there exists a long-felt need in the art for a magnet device that will prevent metal items from being suctioned into the vacuum cleaner and therefore causing damage to the vacuum.

The subject matter disclosed and claimed herein, in one embodiment thereof, comprises a magnet device. The device is comprised of a wire mesh, a magnet, and a telescoping arm. In the preferred embodiment, the wire mesh is comprised of at least one opening that allows a user to remove the wire mesh from the magnet when it is time to dispose of the collected metal items. The magnet is preferably comprised of at least one magnetic base, at least one magnetic support, and at least one magnetic topper. The magnetic base acts as the primary magnet for the device so that a user can easily pick up small to medium-sized metallic items without causing strain or injury to their back or other muscles. The device is also comprised of a telescoping arm which allows the device to be used at a plurality of distances. In this manner, the user can easily retrieve items without the need to bend over.

Accordingly, the magnet device of the present invention accomplishes all of the foregoing objectives and provides an improved means to collect metallic items. Further, the magnet device can be inserted into a vacuum to prevent damage from accidentally suctioning the metal objects. In addition, the magnet device can be used without bending over to eliminate potential strain or injury on the back and other muscles.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a magnet device that allows a user to easily pick up small to medium-sized metallic items without causing strain or injury to their back or other muscles. The device is primarily comprised of a wire mesh and a magnet. In the preferred embodiment, the magnet is comprised of at least one magnetic base, at least one magnetic support, and at least one magnetic topper. The magnetic base acts as the primary magnet for the device. The magnetic base may be made of any magnetic material known in the art that allows a user to easily pick up small to medium-sized metallic items. The magnetic support is connected on its bottom surface to the magnetic base and on its top surface to the magnetic topper to provide structural integrity of the magnet device. The magnetic support may be made of any magnetic material known in the art that allows a user to pick up small to medium-sized metallic items.

In the preferred embodiment, the wire mesh is comprised of at least one opening that allows a user to remove the wire mesh from the magnet when it is time to dispose of the collected metal items. The wire mesh is made from a plurality of layers of wire that form a plurality of overlapping openings. Therefore, the openings allow the user to remove the wire mesh but are not big enough to allow the metal objects to enter the wire mesh.

In further embodiments, the device may be comprised of a wire mesh, a magnet, and a telescoping arm. The telescoping arm is comprised of a rotator, a light, a battery, and a button. The rotator may be fixed to the wire mesh and magnet in order to allow the two parts to rotate 360 degrees to make accessing hard to reach areas easier. The light may be fixed to the telescoping arm to allow dark spaces to be illuminated in order to identify the metallic items. The battery may also be fixed to the telescoping arm to provide a source of power for the light. The battery is comprised of a USB port to allow for a user to charge the battery when it is depleted.

Accordingly, the magnet device of the present invention is particularly advantageous as it allows the user to pick up small to medium-sized metal objects without bending over and potentially straining or injuring themselves. In addition, the magnet device of the present invention is particularly advantageous as it allows the user to suction metal objects using a vacuum without the metal objects causing damage to the vacuum. In this manner, the magnet device provides a novel solution to picking up small magnetic items.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of a magnet device of the present invention in accordance with the disclosed architecture;

FIG. 2 illustrates a side perspective view of one potential embodiment of a magnet device of the present invention in accordance with the disclosed architecture; and

FIG. 3 illustrates a front perspective view of one potential embodiment of a magnet device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved magnet device. There also exists a long-felt need in the art for a magnet device that can be used without the need to bend over to grab metal items such as hairpins or screws in an effort to avoid stress on the back and other muscles. In addition, there exists a long-felt need in the art for a magnet device that will prevent metal items from being suctioned into the vacuum cleaner and therefore causing damage to the vacuum.

The present invention, in one exemplary embodiment, is comprised of a magnet device. The device is primarily comprised of a wire mesh and a magnet. In the preferred embodiment, the magnet is comprised of at least one magnetic base, at least one magnetic support, and at least one magnetic topper. The magnetic base acts as the primary magnet for the device. The magnetic base may be made of any magnetic material known in the art that allows a user to easily pick up small to medium-sized metallic items. The magnetic support is connected on its bottom surface to the magnetic base and on its top surface to the magnetic topper to provide structural integrity of the magnet device. The magnetic support may be made of any magnetic material known in the art that allows a user to pick up small to medium-sized metallic items. The magnetic topper is connected on its bottom surface to the top surface of the magnetic support to allow for another magnetic point in which metallic items can be retrieved.

In the preferred embodiment, the wire mesh is comprised of at least one opening that allows a user to remove the wire mesh from the magnet when it is time to dispose of the collected metal items. In the preferred embodiment, the wire mesh is made from a plurality of layers of wire that form a plurality of overlapping openings. Therefore, the openings allow the user to remove the wire mesh but are not big enough to allow the metal objects to enter the wire mesh.

In further embodiments, the device may be comprised of a wire mesh, a magnet, and a telescoping arm. The telescoping arm is comprised of a rotator, a light, a battery, and a button. The rotator may be fixed to the wire mesh and magnet in order to allow the two parts to rotate 360 degrees to make accessing hard to reach areas easier. The light may be fixed to the telescoping arm to allow dark spaces to be illuminated in order to identify the metallic items. The battery may also be fixed to the telescoping arm to provide a source of power for the light. The battery is comprised of a charging port to allow for a user to charge the battery when it is depleted.

Accordingly, the magnet device of the present invention is particularly advantageous as it allows the user to retrieve small to medium-sized metallic objects without bending over and risking injury. In this manner, the magnet device overcomes the limitations of existing magnet devices known in the art.

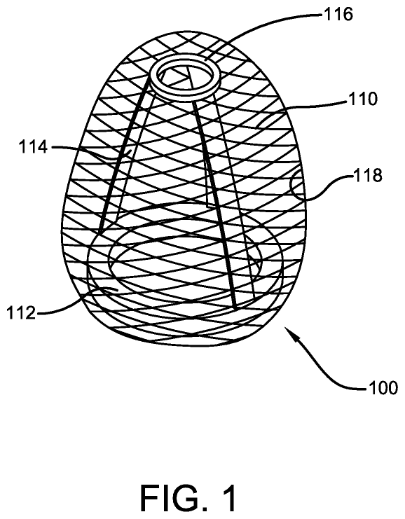

Referring initially to the drawings, FIG. 1 illustrates a front perspective view of one potential embodiment of a magnet device 100 of the present invention in accordance with the disclosed architecture. The device 100 is primarily comprised of a wire mesh 110, at least one magnetic base 112, at least one magnetic support 114 attached to the magnetic base, and at least one magnetic topper 116 attached to the magnetic support 114. In differing embodiments, the magnetic base 112 and the magnetic topper 116 may be a plurality of shapes such as but not limited to square, rectangle, triangle, circle, oval, pentagon, octagon, etc., or any shape that allows the device 100 to fit partially or completely into an existing vacuum arm or another vacuum of the like. In the preferred embodiment, the magnetic base 112, the magnetic support 114, and the magnetic topper 116 may be manufactured from a magnetic metal material such as, but not limited to, iron, nickel, cobalt, steel, rare earth elements, alnico alloys, ferromagnetic alloys, etc.

In the preferred embodiment, the wire mesh 110 is made from a plurality of layers of wire that form a plurality of overlapping openings 118. In this manner, the openings 118 allow the vacuum suction to proceed unobstructed but are not big enough to allow small to medium-sized metal objects to enter the device 100 through the wire mesh 110. The wire mesh 110 may be of any spacing known in the art. The wire mesh 110 may be fixedly attached to the base 112. The mesh 110 may also be removably attached to the magnetic base 112 to allow for the removal of the wire mesh 110 to discard any metal items that were retrieved using the device 100. In the preferred embodiment, the wire mesh 110 may be manufactured from a metal material such as, but not limited to, stainless steel, tool steel, alloy steel, carbon steel, galvanized steel wire, etc.

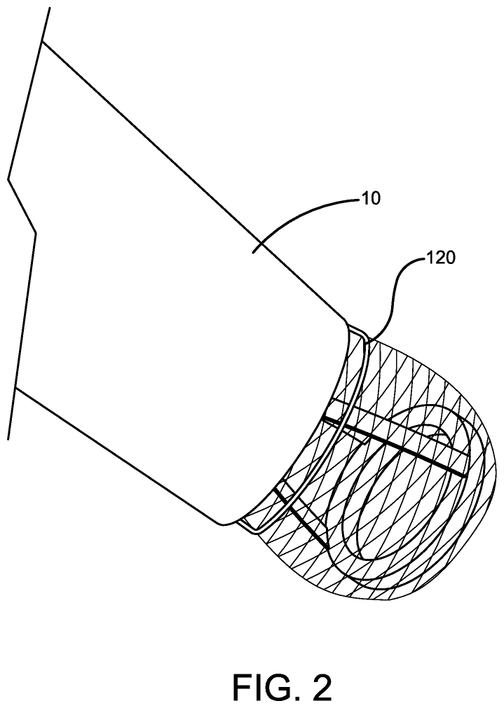

FIG. 2 illustrates a side perspective view of one potential embodiment of a magnet device 100 of the present invention in accordance with the disclosed architecture. The device 100 is comprised of at least one O-ring 120 which provides a seal between the vacuum opening 10 and the device 100 to ensure the proper suction rate works without obstruction. The O-ring 120 may be manufactured from any heat-resistant plastic known in the art such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In a differing embodiment, the O-ring 120 may be manufactured from a waterproof, flexible material such as, but not limited to, nitrile, neoprene, ethylene propylene, silicone, fluorocarbon, Teflon, etc. During use, this embodiment of the device 100 can be used with an existing vacuum and placed in the vacuum opening 10 to prevent metal objects from entering the opening 10, while also collecting the metal objects.

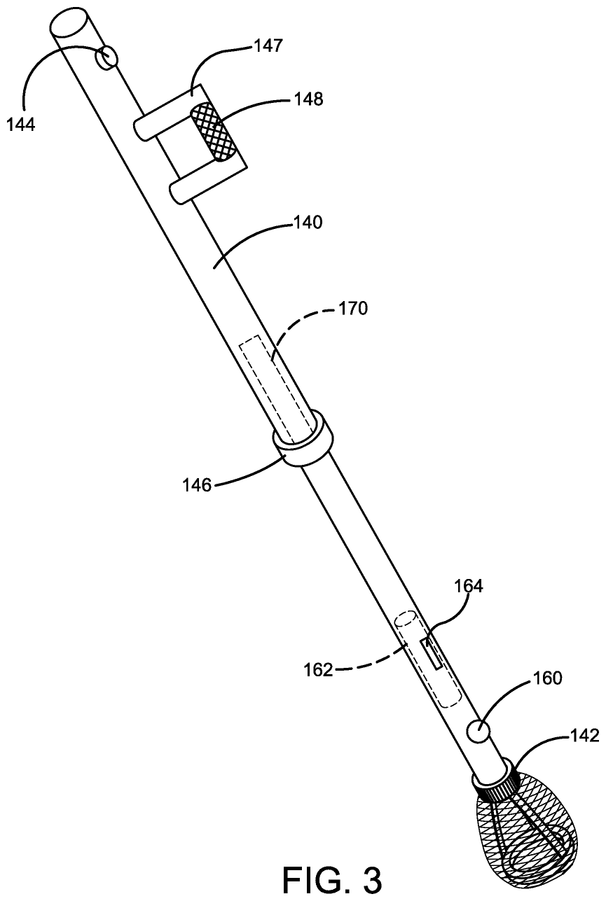

FIG. 3 illustrates a front perspective view of one potential embodiment of a magnet device 100 of the present invention in accordance with the disclosed architecture. The device 100 may also be comprised of at least one telescoping arm 140. The telescoping arm 140 can be made from a metal such as, but not limited to, sheet metal, stainless steel, galvanized steel, black steel, black iron, brass, nickel alloys, carbon steel, duplex steel, copper nickel, titanium, cast iron, aluminum, etc. This embodiment of the device 100 is not intended to be used with a vacuum, but rather as a stand-alone device.

The telescoping arm 140 may be comprised of at least one rotating member 142, at least one button 144, at least one light 160, and at least one battery 162. The rotating member 142 can be any member known in the art such as, but not limited to, a rotary joint, a swivel joint, a straight-through joint, a right-angle joint, an offset joint, etc. The rotator 142 allows the arm 140 to rotate 360 degrees around the magnetic base 112, support 114, and topper 116. In this manner, the device 100 is able to maneuver areas that may be difficult to reach.

The telescoping arm 140 may be comprised of at least one locking member 146. The locking member 146 may be any mechanism known in the art, such as, but not limited to, a locking ring. The member 146 allows the arm 140 to be secured at a desired length.

The arm 140 may also be comprised of at least one handle 147. The handle 147 may be comprised of at least one grip area 148. The grip area may be textured with a recessed or raised texture or may be non-textured. The grip area is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc. The grip area 148 may be located on any portion of the arm 140 in differing embodiments. In one embodiment, the grip area 148 is comprised of a foam material. Said material includes but is not limited to polyurethane foam, polyester foam, ethafoam, memory foam, lux foam, rebond foam, latex foam, etc.

The telescoping arm 140 may be comprised of at least one button 144. The button 144 allows the device's 100 magnetic pull to disable in order to release the collected metallic objects that are stuck to the wire mesh 110. To do so, the device 100 is comprised of a voltage motor that produces an AC current. The current travels into the base 112, support 114, and topper 116 to demagnetize the base 112.

The telescoping arm 140 may be comprised of at least one light 160. The light 160 can be any light known in the art such as, but not limited to, an LED. In this manner, the light 160 allows the user to illuminate dark spaces in order to see while using the device 100. The light 160 is comprised of a battery 162. The battery 162 may be a disposable battery 162 or a rechargeable battery 162 in the form of an alkaline, nickel-cadmium, nickel-metal hydride battery 162, etc. such as any 3V-12 volts DC battery 162 or other conventional battery 162 such as A, AA, AAA, etc. that supply power to the device 100. Throughout this specification the terms “battery” and “batteries” may be used interchangeably to refer to one or more wet or dry cells or batteries 162 of cells in which chemical energy is converted into electricity and used as a source of DC power. References to recharging or replacing batteries 162 may refer to recharging or replacing individual cells, individual batteries 162 of cells, or a package of multiple battery cells as is appropriate for any given battery 162 technology that may be used.

The battery 162 may be comprised of at least one charging port 164. In the preferred embodiment, the charging port 164 may be a USB port. In this manner, the user will be able to recharge the battery 162 so that the light 160 can maintain its function. In differing embodiments, the charging port 164 can be any charging port known in the art such as, but not limited to, a USB-A port, a USB-B port, a micro-USB port, a mini-USB port, a USB-C port, a lightning port, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “magnetic device” and “device” are interchangeable and refer to the magnetic device 100 of the present invention.

Notwithstanding the foregoing, the magnetic device 100 of the present invention and its various components can be of any suitable size and configuration as is known in the art without affecting the overall concept of the invention, provided that they accomplish the above-stated objectives. One of ordinary skill in the art will appreciate that the size, configuration and material of the magnetic device 100 as shown in the FIGS. are for illustrative purposes only, and that many other sizes and shapes of the magnetic device 100 are well within the scope of the present disclosure. Although the dimensions of the magnetic device 100 are important design parameters for user convenience, the magnetic device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A magnet device comprising:
a member comprised of a base, a support and a topper; and
a wire mesh that encloses the member.

2. The magnet device of claim 1, wherein the member is comprised of a magnetic material.

3. The magnet device of claim 1, wherein the base is comprised of a magnetic material.

4. The magnet device of claim 1, wherein the support is comprised of a magnetic material.

5. The magnet device of claim 1, wherein the topper is comprised of a magnetic material.

6. The magnet device of claim 1, wherein the wire mesh is comprised of a magnetic metal material.

7. A magnet device comprising:
a magnetic member comprised of a magnetic base, a magnetic support, and a magnetic topper;
a wire mesh that encloses the magnetic member; and
a telescoping arm.

8. The magnet device of claim 7, wherein the wire mesh is comprised of a plurality of overlapping layers of wire mesh.

9. The magnet device of claim 7, wherein the wire mesh removably attaches to the magnetic member.

10. The magnet device of claim 7 further comprising an O-ring.

11. The magnet device of claim 7, wherein the magnetic member attaches to the telescoping arm.

12. A magnet device comprising:
a magnetic member comprised of a magnetic base, a magnetic support and a magnetic topper;
a wire mesh that encloses the magnetic member;
a telescoping arm;
a button;
a battery; and
a light.

13. The magnet device of claim 12, wherein the battery supplies power to the light.

14. The magnet device of claim 12, wherein the battery is comprised of a charging port.

15. The magnet device of claim 14, wherein the charging port is comprised of a USB port.

16. The magnet device of claim 12 further comprised of a rotator.

17. The magnet device of claim 16, wherein the rotator is comprised of a rotary joint, a swivel joint, a straight-through joint, a right-angle joint or an offset joint.

18. The magnet device of claim 16, wherein the rotator attaches the magnetic member to the telescoping arm.

19. The magnet device of claim 16, wherein telescoping arm rotates 360 degrees around the magnetic member via the rotator.

20. The magnet device of claim 12, wherein the light is comprised of an LED light.
